(19) United States
(12) Patent Application Publication
(10) Pub. No.: US 2006/0016116 A1
(43) Pub. Date: Jan. 26, 2006

(54) Center ring structure for a fishing rod

(76) Inventor: Moon-jae Yu, Seoul (KR)

Correspondence Address: Mark G. Lappin;McDermott Will & Emery LLP, 28 State Street, Boston, MA, 02109, US

(21) Appl. No.: 10/899,364

(22) Filed: Jul. 26, 2004

(51) Int. Cl. A01K 87/04

(52) U.S. Cl. 43/24

(57) ABSTRACT

Disclosed herein is a center ring structure for a fishing rod, a plurality of center rings being provided on the fishing rod for guiding a fishing line. Each of these center rings is defined in a frame so as to penetrate through, and the frame comprises a surface contact recess formed at a lower side of the frame for allowing the frame to come into partial contact with an outer peripheral surface of the fishing rod or with a mount ring slidably fitted around the fishing rod, and a guiding groove formed along an outer periphery of the frame for winding a thread around the frame and the fishing rod so as to fix them relative to each other. The present invention can simplify the center ring structure by allowing the center ring itself to be affixed to the fishing rod, and can allow adjustment of the distance between the center ring and the fishing rod through variation in shape and size of a center ring aperture formed in the frame.

### BACKGROUND OF THE INVENTION

1. Field of the Invention

The present invention relates to a center ring structure for a fishing rod, and more particularly to a center ring structure for a fishing rod, which can simplify the structure of fishing line guide means by allowing a center ring to be affixed to the fishing rod, and can allow adjustment of the distance between the center ring and the fishing rod through the variation in shape and size of a center ring aperture formed in a frame.

2. Description of the Related Art

In general, fishing rods have a plurality of guide means mounted in a longitudinal direction thereof, each of which is formed with a center ring for guiding a fishing line.

Referring to FIGS. 1 and 2 illustrating a conventional structure disclosed in Japanese Patent Registration No. 3077839, a center ring 5 for guiding a fishing line is adjoined to a tubular guide ring 2 which is fitted around a fishing rod 1, preventing fluctuation thereof.

That is, the fishing rod 1 is inserted in the tubular guide ring 2, and the guide ring 2, in turn, comes into external contact with an annular flexible member 4.

The tubular guide ring 2 has a greater width than the annular flexible member 4.

Inside the annular flexible member 4 occurs interference fitted the center ring 5 for guiding a fishing line.

The guide ring 2 and the flexible member 4 are both surrounded by a fixing guide 3 so that they come into contact with and are fixed to each other.

In this case, since the guide ring 2 wraps the fishing rod 1 over a large area, it can be stably fixed to the fishing rod 1.

Such a large contact area between the fishing rod 1 and the guide ring 2, however, may cause the fishing rod 1 to be distorted when being bent and may cause damage to joint portions thereof, and may also result in deterioration of the elasticity of the fishing rod 1.

As part of efforts to solve the above problem, U.S. Pat. No. 4,467,549 discloses a structure as shown in FIGS. 3 and 4. In the disclosed structure, a fishing rod 10 is in contact with a guide ring 12 over a small area, securing smooth bending thereof.

That is, the fishing rod 10 is inserted through the guide ring 12 having only a narrow width, and the guide ring 12 comes into external contact with a center ring 15.

In this case, at an outer peripheral surface of the center ring 15 in contact with the guide ring 12 is formed a longitudinal recess 16 so that the guide ring 12 is partially seated therein, thereby preventing the guide ring 12 from rolling along the outer peripheral surface of the center ring 15.

In addition, throughout an outer periphery of the center ring 15 is formed a circumferential recess 17 in order to guide a thread 18 for binding the center ring 15 with the guide ring 12.

Inside the seal 18, outside of both the guide ring 12 and the center ring 15, is filled a synthetic resin material 19 for fixing the guide ring 12 and the center ring 15 relative to each other.

Such a conventional center ring as stated above, although it is fixed to the outside of the fishing rod by being wound by the thread, fails to secure a sufficient spacing with the fishing rod.

In order to space the conventional center ring from the fishing rod by a desired distance, although filling a synthetic resin material between the center ring and the fishing rod and surrounding them with the seal has been tried, it may cause unintentional separation of the synthetic resin material in case of movement of the center ring due to a tensioned fishing line therein.

### SUMMARY OF THE INVENTION

Therefore, the present invention has been made in view of the above problems, and it is an object of the present invention to provide a center ring structure for a fishing rod which is designed so that a frame, in partial, external contact with the fishing rod, is formed with a center ring, and an adhesive is applied to a thread by winding the thread on both the fishing rod and the frame so as to increase the strength of the thread, thereby securing firm attachment between the frame and the fishing rod, and which can allow adjustment of the distance between the center ring and the fishing rod through variation in shape and size of the center ring relative to the frame as occasion demands.

In accordance with the present invention, the above and other objects can be accomplished by the provision of a center ring structure for a fishing rod, a plurality of center rings being provided on the fishing rod for guiding a fishing line, wherein each of the center rings is defined in a frame so as to penetrate through, wherein the frame comprises: a surface contact recess formed at a lower side of the frame for allowing the frame to come into partial contact with an outer peripheral surface of the fishing rod or with a mount ring slidably fitted around the fishing rod; and a guiding groove formed along an outer periphery of the frame for winding a thread around the frame and the fishing rod so as to fix them relative to each other.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are a longitudinal side view and a sectional view, respectively, illustrating the structure of a center ring fixed to a fishing rod in accordance with an embodiment of the prior art;

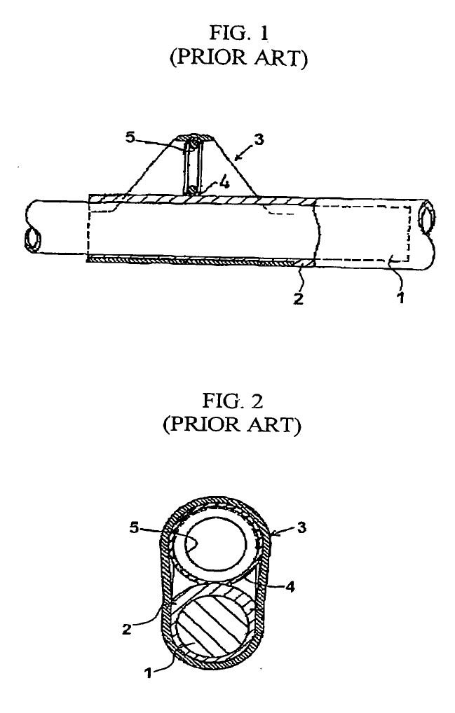

FIGS. 3 and 4 are a longitudinal side view and a sectional view, respectively, illustrating the structure of a center ring fixed to a fishing rod in accordance with another embodiment of the prior art;

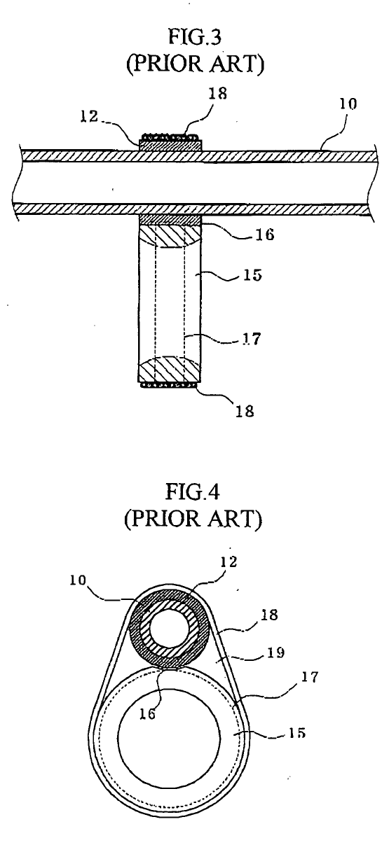

FIG. 5 is a perspective view illustrating center rings fixed to a fishing rod in accordance with a first embodiment of the present invention;

FIGS. 6 and 7 are a longitudinal side view and a sectional view, respectively, illustrating the structure of the center ring fixed to a fishing rod in accordance with the first embodiment of the present invention;

FIGS. 8 to 10 are sectional views illustrating the structure of different center rings fixed to a fishing rod in accordance with second to fourth embodiments of the present invention, respectively; and

FIGS. 11 and 12 are a longitudinal side view and a sectional view, respectively, illustrating the structure of a center ring fixed to a fishing rod in accordance with a fifth embodiment of the present invention.

### DESCRIPTION OF THE PREFERRED EMBODIMENTS

Now, preferred embodiments of the present invention will be described in detail with reference to the annexed drawings.

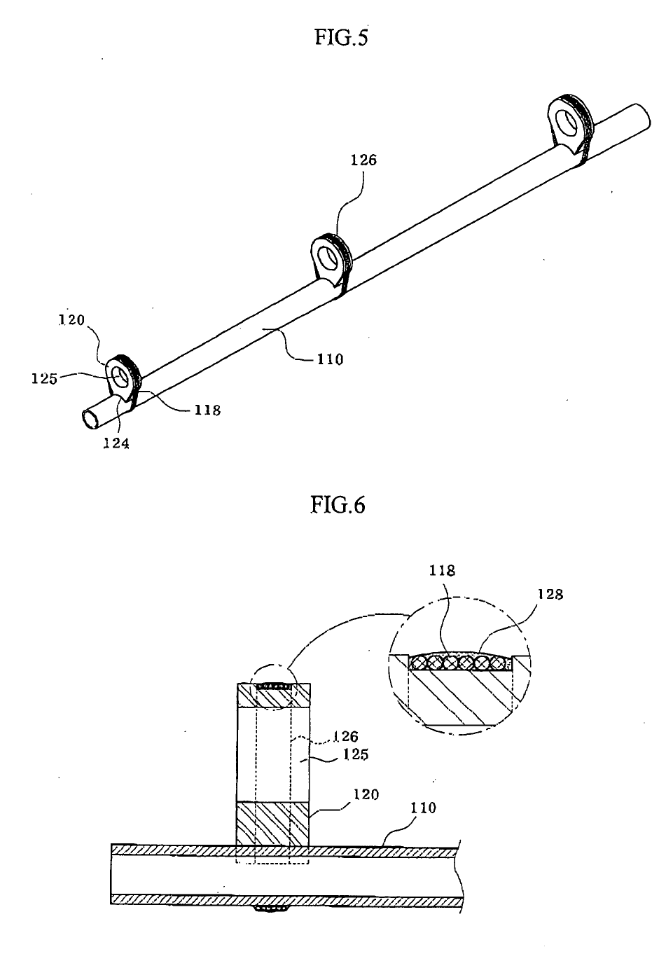

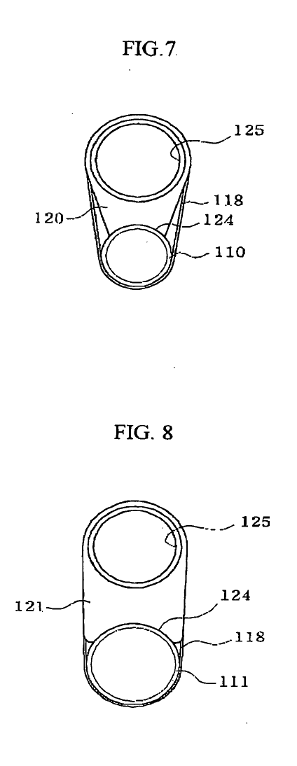

FIG. 5 is a perspective view illustrating center rings fixed to a fishing rod in accordance with a first embodiment of the present invention. FIGS. 6 and 7 are a longitudinal side view and a sectional view, respectively, illustrating the structure of one of the center rings fixed to a fishing rod in accordance with the first embodiment of the present invention.

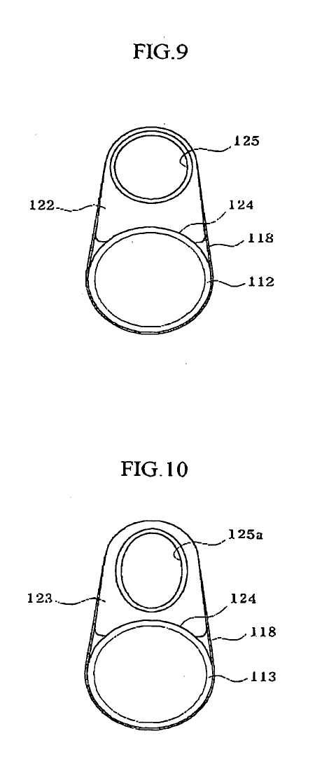

In addition, FIGS. 8 to 10 are sectional views illustrating the structure of different center rings fixed to a fishing rod in accordance with second to fourth embodiments of the present invention, respectively.

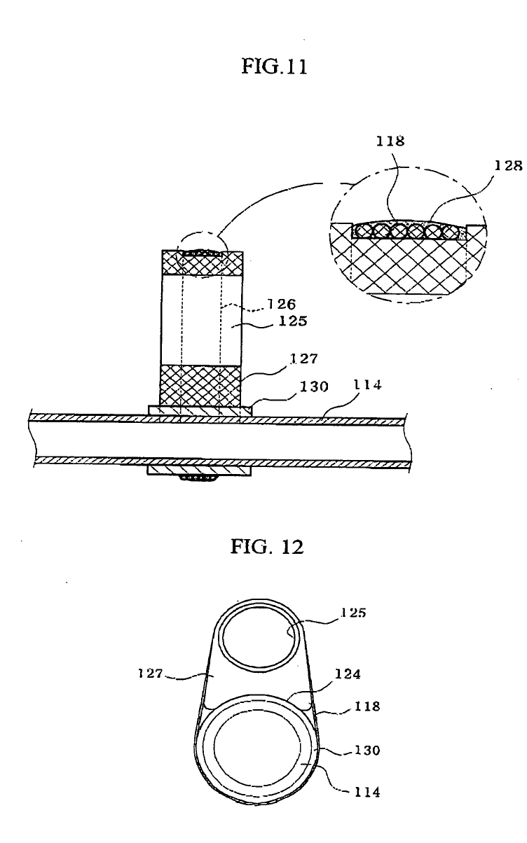

Finally, FIGS. 11 and 12 are a longitudinal side view and a sectional view, respectively, illustrating the structure of a center ring fixed to a fishing rod in accordance with a fifth embodiment of the present invention.

As shown in FIGS. 5 to 12, the present invention features a structure wherein a plurality of center rings 125 or 125a are provided on a fishing rod 110, 111, 112, 113 or 114 for guiding a fishing line. The respective center rings 125 and 125a are centrally defined in frame 120, 121, 122, 123 or 127 so as to penetrate through. Frame 120, 121, 122, 123 or 127 is formed at a lower side thereof with a surface contact recess 124, so that frame 120, 121, 122, 123 or 127 comes into partial contact with an outer peripheral surface of the fishing rod 110, 111, 112, 113 or 114 or a mount ring 130 slidably fitted around the fishing rod 110, 111, 112, 113 or 114. The frame 120, 121, 122, 123 or 127 is also formed with a guiding groove 126 along an outer periphery thereof for guiding a thread 118. As the thread 118 is wound along the guiding groove 126, frame 120, 121, 122, 123 or 127 is fixed to the fishing rod 110, 111, 112, 113 or 114.

Referring to FIGS. 5 to 7 illustrating a first embodiment of the present invention, a plurality of the frames 120 are longitudinally affixed to the fishing rod 110.

The frames 120, each taking the form of a plate, are affixed so as to come into contact, at one end thereof, with the fishing rod 110.

At the lower side of the respective frames 120 is depressed the surface contact recess 124, so that part of the outer peripheral surface of the fishing rod 110 is received in the recess 124 in a surface contact manner.

In this case, the surface contact recess 124 has a contour corresponding to that of the outer peripheral surface of the fishing rod 110 such that it comes into close contact with the fishing rod 110.

Such a surface contact recess 124 enables the frame 120 to be stable and closely supported on the fishing rod 110 even with a minimal contact area between. This has an effect of preventing the frame 120 from interfering with bending of the fishing rod 110.

The frame 120 is perforated so as to form the center ring 125.

The center ring 125 has a circular or polygonal shape, and is variable in its position on the frame 120 in order to enable adjustment of the distance between the center ring 125 and the fishing rod 110.

In addition, along the outer periphery of the frame 120 is formed the guiding groove 126.

Preferably, the guiding groove 126 is formed throughout the outer periphery of the frame 120 except for the surface contact recess 124.

When the frame 120 is in contact with the fishing rod 110, the thread 118 is wound along the guiding groove 126 in order to affix the frame 120 to the fishing rod 110 without a risk of unintentional secession.

In this way, after the surface contact recess 124 of the frame 120 comes into contact with the fishing rod 110, and the thread 118 is wound around the frame 120, an adhesive 128 is applied thereon in order to enhance firm attachment between.

The adhesive 128, applied on the thread 118, has an additional effect of increasing the rigidity of the thread 118, thereby allowing the frame 120 to be firmly affixed to the fishing rod 110 when a fishing line is tensioned.

The frame 120 is made of a material having good durability, such as a ceramic material, thereby preventing it from being worn or damaged due to abrasion by a fishing line.

As shown in FIG. 7, if the diameter of the fishing rod 110 is smaller than the diameter of the center ring 125, the frame 120 is shaped so that the width thereof is narrowed downward from its upper side formed with the center ring 125 to its lower side formed with the surface contact recess 124.

Referring now to FIG. 8, if the diameter of the fishing rod 111 is equal or similar to the diameter of the center ring 125, there may be provided the frame 121 having a constant width at upper and lower sides thereof.

Referring now to FIG. 9, if the diameter of the fishing rod 112 is larger than the diameter of the center ring 125, there may be provided the frame 122 wherein the width thereof is widened downward from its upper side to its lower side, enhancing contact stability of the frame 122 on the fishing rod 112.

Referring now to FIG. 10, the frame 123 comes into contact, at the surface contact recess 124 thereof, with the fishing rod 113, and is affixed thereto as the thread 118 is wound around both the frame 123 and the fishing rod 113, in the same manner as those of the previous embodiments. However, in the present embodiment, the center ring 125a, which has an elliptical shape is formed in the frame 123. Such an elliptical center ring 125a effectively increases displacement or a fishing line therein in proportion to the intensity of an external tension force.

Referring now to FIGS. 11 and 12, in case of a multistage telescopic type fishing rod 114, mount rings 130 are installed at regular intervals.

In this case, each of the mount rings 130, in a state wherein it comes into partial contact at its outer peripheral surface with the surface contact recess 124 of the frame 127, is affixed relative to the frame 127 as the thread 118 is wound around. The frame 127 is formed with the center ring 125 for guiding a fishing line.

In order to prevent unintentional separation of the thread 118, the frame 127 is formed with the guide groove 126 throughout the outer periphery thereof except for the surface contact recess 124.

To the thread 118 is applied the adhesive 128 in order to increase the rigidity thereof.

As apparent from the above description, the present invention provides a center ring structure for a fishing rod wherein a frame, containing the center ring for guiding a fishing line, takes the form of a plate having a certain thickness, thereby being integrally affixed to the fishing rod. This has an effect of simplifying the structure of guide means as well as reducing a contact area between the frame and the fishing rod, thereby preventing the fishing rod from being distorted when being bent.

Further, since both the frame and the fishing rod are wound by a thread, and an adhesive is applied to the thread in order to firmly fix them, it is possible to prevent fluctuation of the frame. Furthermore, the frame, made of a ceramic material, has an effect of minimizing abrasion by a fishing line.

Finally, by varying the shape of the center ring into a circular or polygonal shape, or adjusting the position of a center ring aperture formed in the frame, it is possible to adjust the distance between the center ring and the fishing rod.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A center ring structure for a fishing rod, a plurality of center rings being provided on the fishing rod for guiding a fishing line, each of the center rings being defined in a frame so as to penetrate there through, said frame comprising:
a surface contact recess formed at a lower side of the frame for allowing the frame to come into partial contact with an outer peripheral surface of the fishing rod or with a mount ring slidably fitted around the fishing rod; and
a guiding groove formed along an outer periphery of the frame for winding a thread around the frame and the fishing rod so as to fix them relative to each other.

2. The structure as set forth in claim 1, wherein the center ring has a circular or elliptical shape.

3. The structure as set forth in claim 1, wherein the frame is made of a ceramic material.

4. The structure as set forth in claim 1, wherein the surface contact recess of the frame and the fishing rod are attached relative to each other by means of an adhesive.

5. The structure as set forth in claim 1, wherein, to the thread, wound around both the frame and the fishing rod, is applied an adhesive in order to increase the strength of the thread.
